(19) United States
(12) Patent Application Publication
(10) Pub. No.: US 2007/0016965 A1
(43) Pub. Date: Jan. 18, 2007

(54) Lockable removable disk drive

(75) Inventors: Raz Dan, San Jose, CA (US); Itzhak Pomerantz, Kfar Saba (IL)

Correspondence Address: DR. MARK FRIEDMAN LTD., C/o Bill Polkinghorn, 9003 Florin Way, Upper Marlboro, MD, 20772, US

(73) Assignee: M-SYSTEMS FLASH DISK PIONEERS LTD.

(21) Appl. No.: 11/318,473

(22) Filed: Dec. 28, 2005

Related U.S. Application Data
(60) Provisional application No. 60/696,706, filed on Jul. 6, 2005.

(51) Int. Cl. G06F 1/26

(52) U.S. Cl. 726/34

(57) ABSTRACT

Systems and methods for reversibly preventing the coupling of a non-volatile memory device to a host device such as a microcomputer are disclosed. Exemplary non-volatile memory devices include but are not limited to hard disk drives and flash memory devices. According to some embodiments, a locking mechanism reversibly prevents physical coupling. According to some embodiments, a mechanical locking mechanism is operative to prevent the coupling of the non-volatile memory to the host device when in a locked configuration, and upon engagement with a proper key the mechanical locking mechanism adopts an unlocked configuration to permit coupling of the non-volatile memory device to the host device. According to some embodiments, a locking mechanism prevents coupling of the non-volatile memory device to the host device without a presence of a proper electronic token.

### CROSS-REFERENCE TO RELATED APPLICATIONS

This patent application claims the benefit of U.S. Provisional Patent Application. No. 60/696,706, filed Jul. 6, 2005 by the present inventors.

### FIELD OF THE INVENTION

The present invention relates to data security, and in particular to systems and methods for reversibly preventing the coupling between a removable non-volatile memory device and a host computer.

### BACKGROUND OF THE INVENTION

Removable non-volatile memory devices such as hard disk drives (HDD) and USB Flash Drives (UFD) provide a convenient medium for the storage of user files and for the transfer of these files between different computers.

Different approaches exist for enabling users to prevent unauthorized access of data stored on portable memory devices, in the event that the device is misplaced or stolen. For example, it is possible to encrypt all data on the nonvolatile memory device using a device such as the dbLock® 5.25″ Secure Bay sold by FireWiremax (Clearwater, Fla.). While these encryption devices provide sufficient security, encryption of data may slow down the communication rate between the disk and the computer and may cause irreversible loss of data if the user loses the encryption key.

Another approach is to include a fingerprint recognition device in the non-volatile memory device. One commercially available UFD with fingerprint recognition is the Security Key Fingerprint Mini Flash Drive, 256 MB, USB 2.0 available from ACP-EP Memory. It is noted that fingerprint recognition devices require that the authorized user pre-store his fingerprints in the memory of the device, and if this is not possible and/or not convenient, there are situations where a user who should be authorized to access data on the device is unable to do so.

Thus, it would desirable to offer a user simple means for locking the data of a removable non-memory device using a physical key. While it is clear that a lock of any type can be bypassed by a locksmith (in the case of a mechanical lock) or by a technician (in the case of an electronic lock) by disassembly and modification of the device, the protection of a lock suffices for many application where the primary concern is unauthorized access by unauthorized employees or other insiders having physical access to the device.

### SUMMARY

The aforementioned needs are satisfied by several aspects of the present invention.

It is now disclosed for the first time a system for providing storage for a host device. The presently disclosed system includes (a) a non-volatile memory device for providing storage to the host when reversibly coupled to the host, and (b) a mechanical locking mechanism having locked and unlocked configurations, the locking mechanism operative to prevent the coupling of the host device to the non-volatile memory device when in the locked configuration, the mechanical locking mechanism operative to adopt the unlocked configuration upon engagement with a proper key.

There is no limit on the particular type of non-volatile memory device, and both hard disk drives as well as USB flash disk drives are within the scope of the present invention.

According to one example, a hard disk drive that is equipped with a lock and a key is provided, where the lock has “closed” (“locked”) and “open” (“unlocked”) configurations. When the key is inserted into the lock, the lock can be positioned—automatically or manually—in the open position. In the open or unlocked position the hard disk drive can be used normally.

When the key is removed or is absent from the lock, the lock becomes “closed” and in this position it cannot be used, either due to a physical obstruction to connecting hard drive to host device (e.g. a microcomputer), or due to a physical disconnection of some critical electric wires, or due to a logical command sent to the host to instructing the host avoid using the disk.

According to another example, a USB flash disk (UFD) with a mechanism adapted to lock the UFD when the UFD is not coupled with the host computer is provided. The lock prevents the UFD from being inserted into the USB port of the host device, and thus a user provided with a locked device needs to first unlock the device (e.g. by providing a proper key) before inserting the UFD into the USB port of the host. The lock can either be built into the UFD, or can be a stand alone component that is attached to the UFD (e.g. a component which obstructs the connector of the UFD) and cannot be removed without a key. Exemplary keys include but are not limited to mechanical keys and electronic tokens.

According to some embodiments, the locking mechanism is a mechanical locking mechanism adapted to physically obstruct a connection between the host device and the non-volatile memory device when in the locked configuration.

According to some embodiments, the locking mechanism in the locked configuration prevents an insertion of the non-volatile memory device into a computer chassis of the host device.

According to some embodiments, the system further includes (c) a connection cable for electrically connecting the non-volatile memory device to the host device for the coupling, wherein the locking mechanism is operative to prevent the electrical connecting when in the locked configuration.

According to some embodiments, the prevention includes a disconnection of electric connectivity.

According to some embodiments, the locked configuration and the unlocked configuration are visibly different.

According to some embodiments, the non-volatile memory device is a USB flash drive.

According to some embodiments, the locking mechanism is an external locking mechanism.

According to some embodiments, the USB flash drive includes an elongated connector having a plurality of holes, and the external locking mechanism includes a mechanism for engaging the holes to prevent insertion of the USB connector into a port of the host device.

According to some embodiments, the external locking mechanism serves as a lockable cap of the USB flash drive.

It is now disclosed for the first time a system for providing storage for a host device. The presently disclosed system includes (a) a non-volatile memory device for providing storage to the host when reversibly coupled to the host, and a locking mechanism for preventing the coupling of the host device to the non-volatile memory device without a presence of a proper electronic token.

According to some embodiments, the non-volatile memory device includes a port for receiving the electronic token.

According to some embodiments, the electronic token is a contactless electronic token.

According to some embodiments, the electronic token is a USB token.

According to some embodiments, an identity of a recognized token is logged.

It is now disclosed for the first time a system for providing storage for a host device. The presently disclosed system includes (a) a non-volatile memory device for providing storage to the host when reversibly coupled to the host; and (b) a locking mechanism for preventing physical coupling of the host device to the non-volatile memory device without a presence of a proper key.

It is now disclosed for the first time a method of securing data, including (a) providing a non-volatile memory device operative to provide storage to a host when reversibly coupled to the host, (b) providing a mechanical locking mechanism having locked and unlocked configurations, the locking mechanism operative to prevent the coupling of the host device to the non-volatile memory device when in the locked configuration, the mechanical locking mechanism operative to adopt the unlocked configuration upon engaging a proper mechanical key, and (c) placing the locking mechanism into the locked configuration to prevent the coupling of the non-volatile memory device.

It is now disclosed for the first time a method of securing data, including (a) providing a non-volatile memory device operative to provide storage to a host when reversibly coupled to the host, (b) providing a locking mechanism for preventing the coupling of the host device to the non-volatile memory device without a presence of a proper electronic token, and (c) placing the locking mechanism into the locked configuration to prevent the coupling of the non-volatile memory device.

It is now disclosed for the first time a method of securing data, including (a) providing a non-volatile memory device operative to provide storage to a host when reversibly coupled to the host, (b) providing a locking mechanism for preventing physical coupling of the host device to the non-volatile memory device without a presence of a proper key, and (c) placing the locking mechanism into the locked configuration to prevent the physical coupling of the non-volatile memory device.

These and further embodiments will be apparent from the detailed description and examples that follow.

### BRIEF DESCRIPTION OF THE DRAWINGS

FIGS. 1A-1B illustrate a system including a removable hard disk drive and a mechanical locking mechanism for reversibly preventing the insertion of the hard disk drive into a computer chassis.

FIGS. 2A-2B illustrate a system including a hard disk drive and a mechanical locking mechanism for reversibly preventing the insertion of a connector into a port of the hard disk drive.

FIGS. 3A-3B illustrate a UFD including a locking mechanism for reversibly preventing the insertion of the UFD connector into a UFD port.

FIGS. 4A-4C illustrate a system including a UFD and a locking mechanism for reversibly preventing the insertion of the UFD connector into a UFD port.

FIG. 5 illustrates a system including a hard disk drive and a locking assembly for reversibly disconnecting an electrical wire

FIG. 6 illustrates a system including a hard disk drive and a device for checking for the presence of an authorized electronic token.

FIG. 7 illustrates a UFD with a port for receiving an electronic token which is operative to authorize usage of the UFD.

### DETAILED DESCRIPTION OF THE INVENTION

Introduction

The present invention will now be described in terms of specific, example embodiments. It is to be understood that the invention is not limited to the example embodiments disclosed. It should also be understood that not every feature of the systems for providing storage for a host device and methods of securing data described is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

The present inventors are now disclosing systems and methods for preventing the coupling or physical coupling of a non-volatile memory device to a host without the possession and/or presence of a proper key.

According to some embodiments, the non-volatile memory device is a hard disk drive, and a mechanism for preventing unauthorized use of a the hard drive is part of the hard drive assembly.

It is noted that according to different embodiments, prevention of use of a hard drive can be effected using one or more the following:
1. Mechanical blocking of the ability of one or more of the HDD connectors to be plugged into a mating connector.
2. Mechanical blocking of the ability to insert the HDD into its place within the computer chassis.
3. Electronic disconnection of a power line or a data line that is necessary for proper operation of the HDD.
4. In cooperation with the operating system of the computer, maintaining a logical status that denies access to the disk.
   According to various embodiments, the locking mechanism includes one or more of the following:
1. A mechanical lock that, when activated by a matching key, is movable to position a mechanical member into and out of a position that prevents the usage.
2. A combination lock that, when activated by the correct sequence of numbers, is movable to position a mechanical member into and out of a position that prevents the usage.
3. An electronic lock that, upon detection of the correct token or recognition of the correct password, activates an electronic device such as an electronic switch, electromagnet or a motor, that enables or disables the use of the HDD by introduction or cancellation of the above exemplified prevention means.

In one of many preferred embodiments of the invention, the locking mechanism which prevents insertion of the HDD into the host computer is further operative to prevent the removal of the removable HDD from the host computer, thus protecting HDD from being stolen from the host computer.

Certain embodiments of the invention relate to methods and systems of protecting a UFD protected from unauthorized use in a computer, by physically locking the UFD when removed from the computer.

In one preferred embodiment the UFD has a built-in lock that has locked and unlocked configurations, where when locked, a physical member extends to a position that prevents insertion of the USB connector into a USB socket.

In another preferred embodiment, there is provided a special USB connector lock, that can be connected to any USB plug or connector and lock on the USB plug in a manner that prevents use of the plug.

In yet another preferred embodiment of this invention, a UFD is locked by an electronic token (USB token), so that the UFD can only be used if the token is plugged into it. This is an electronic alternative to the physical key lock. It should be noted that in this preferred embodiment, the UFD can accept a plurality of alternative tokens, and can log report or report in real time the identity of the token, for purposes of inventory control and billing.

### DETAILED DESCRIPTION OF THE DRAWINGS

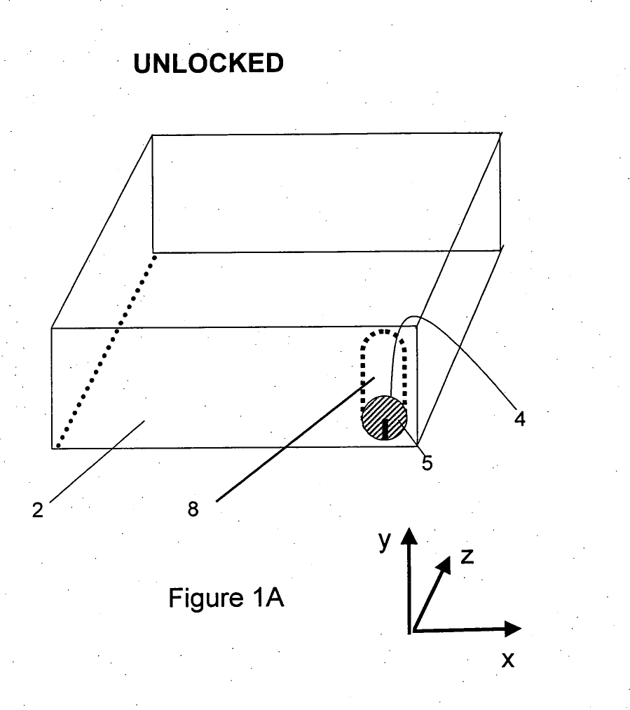

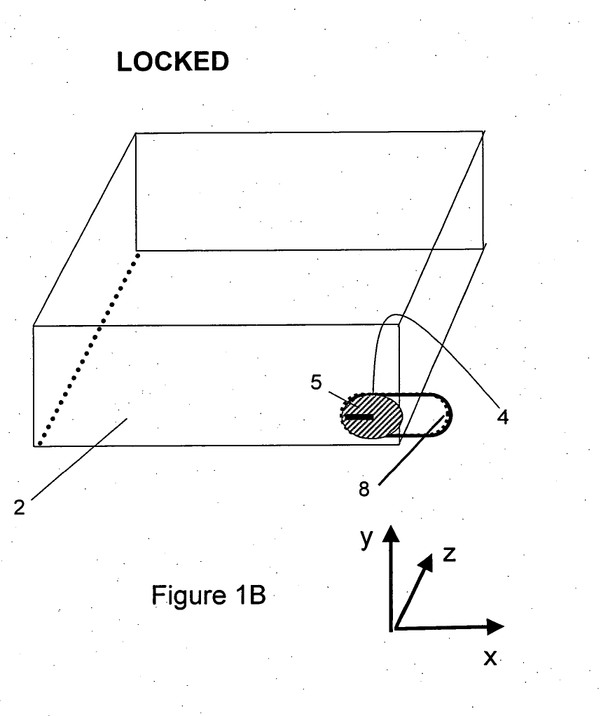

Referring now to the drawings, FIG. 1A-1B describes a system including a non-volatile memory device (e.g. a removable hard disk drive including a drive 2) and a mechanical lock 4. When the removable hard disk drive is inserted into the hard drive bay of a computer chassis (not shown) of a host device (e.g. the computer housed within the computer chassis), the non-volatile memory device may be “physically coupled” to the host device, i.e. the non-volatile memory device (e.g. the HDD) may be electrically connected to the host device housed within the computer chassis. According to the example of FIG. 1, inserting the hard drive is effected by relative motion between the hard drive and the hard drive bay along the z axis.

Furthermore, it is noted that the mechanical lock 4 includes a rotatable rigid mechanical tab 8. Thus, the mechanical lock 4 has both “unlocked” (shown in FIG. 1A) and “locked” (shown in FIG. 1B) configurations. When the mechanical lock 4 is in the locked configuration (as shown in FIG. 1B), the rigid mechanical tab 8 has a horizontal orientation, and protrudes beyond the hard drive housing 2 to prevent physical coupling between the non-volatile memory device and the host device, i.e. by obstructing the hard drive from being inserted into the hard drive bay. When the mechanical lock is in the unlocked configuration (as shown in FIG. 1A), the mechanical tab 8 has a vertical orientation, and the hard disk drive may be inserted into the hard drive bay.

When the mechanical lock 4 is in the locked configuration (i.e. when the mechanical tab 8 has a horizontal orientation), the mechanical tab 8 is prevented from rotating by an internal locking mechanism (not shown). When a proper mechanical key is inserted into the key hole 5 of the mechanical lock, the mechanical tab may be rotated in the counter-clockwise direction so that the mechanical lock 4 adopts the “unlocked” configuration, thereby allowing the insertion of the hard drive into the hard drive bay.

Referring once more to FIG. 1B, it is noted that in some embodiments, the preventing of coupling or of physical coupling is accomplished by physically obstructing the insertion the device or a portion thereof into a receiving port or a receiving bay.

It is noted that the mechanical lock of FIG. 1 is operative to prevent both “coupling” as well as “physical coupling” between the non-volatile memory device and the host device (i.e. the computer). It is noted that term “coupled” between the non-volatile memory and the device refers to a status where the non-volatile memory device is operative to store data received from the host device in non-volatile memory and/or to retrieve to the host data from non-volatile memory.

The term “physical coupled” refers to the physical configuration of the non-volatile memory device relative to the host where an electrical circuit is completed between the host device and control circuitry of the non-volatile memory device.

Thus, there are many situations where the non-volatile memory device may be “physically coupled” to the host but not “coupled” to the host. For example, some non-volatile memory devices receive a password from the host as part of an authorization process, where only after the proper password is received is it permitted for the device to the host to receive data stored in non-volatile memory and/or for the device to write in non-volatile memory data received from the host. Thus, according to this example, at a time when this non-volatile memory device receives an incorrect password, the non-volatile memory device is “physically coupled” to the host but is not “coupled” to the host because the host is not authorized to read data from the non-volatile memory and the host is not authorized to write data to the non-volatile memory. Thus, because “physical coupling” is necessary for “coupling” but is not sufficient, any locking mechanism which prevents “physical coupling” also prevents coupling.

Furthermore, we note that although locks may be said to “prevent” coupling or physical coupling, it is appreciated that many locks may be circumvented. Thus, for the purposes of this disclosure the term “prevent” as it relates to mechanical locks is defined as preventing coupling (or physical coupling) without comprising the integrity of the lock by, for example, physically hacking the lock, breaking the lock, and the like. For the case of an electronic lock, the term “prevent” is defined as preventing coupling and/or physical coupling without electronically hacking the lock.

Referring once again to FIG. 1, it is noted that in some embodiments, the locking mechanism 4 may also be used to prevent removal of the hard disk drive from the computer chassis, and thus the locking mechanism 4, in some embodiments, functions as an anti-theft device. Furthermore, it is noted that in some embodiments, the tough, rigid mechanical locking tab 8 may, when locked, create a positive tightening pressure that does not leave substantially any slack and that substantially prevents motion between the connector of the hard disk drive and the connector of the computer when the hard drive is in the disk drive bay and physically coupled to the computer host device. It is disclosed that the prevention of motion between the connector of the hard disk drive and the connector of the computer reduces the risk that one or more wires of the connector could be pulled out during a theft attempt, something which could be dangerous to the data and the disk.

It is noted that the locking mechanism 4 of FIG. 1 is a “mechanical locking” mechanism. A “mechanical” locking mechanism is defined as a mechanism that includes at least one moving part mechanically engaged by the key, where mechanical motion of the key is operative to bring the locking mechanism from a “locked” configuration and to an “unlocked” configuration. In contrast, a fingerprint recognition device for allowing or denying access to a UFD does not have any moving parts, and thus fingerprint recognition devices are not considered “mechanical” locking mechanisms'

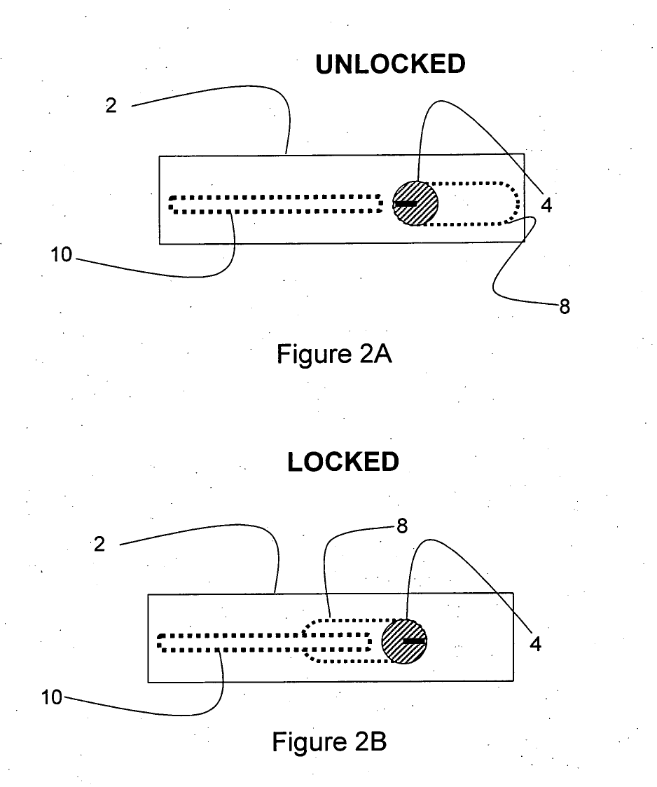

FIG. 2 provides an illustration of another system including a non-volatile memory device and a mechanical locking mechanism. In particular, the system of FIG. 2 includes a hard disk drive 2 having a device port 10 (e.g. a parallel port, a USB port, or any other port) for receiving a connector cable (not shown). Furthermore, a mechanical lock 4 including a rotatable rigid mechanical tab 8 is also provided, where the mechanical lock 4 has both “unlocked” (shown in FIG. 2A) and “locked” (shown in FIG. 2B) configurations. When the mechanical lock is in the “locked” configuration (in FIG. 2B), the rigid mechanical tab 8 blocks the device port 10 from receiving the end of the cable to mate with the cable and thus prevents the hard drive from coupling with the computer host device. When the lock is in the “locked” configuration (e.g. when the rigid mechanical tab 8 at least partially blocks the device port 10), the mechanical tab is prevented from rotating with an internal mechanism (not shown), and it is necessary to engage the mechanical lock 4 with a key in order to turn the mechanical tab 8 to unlock the mechanical lock 4.

Furthermore, it is noted that in some embodiments, the characteristic dimensions of the mechanical tab 8 are on the same order of magnitude as the characteristic dimensions of the port 10, and the difference between the locked configuration and the unlocked configuration is visible to the user. The fact that the device is obvious locked provides a useful deterrent to potential unauthorized users, especially employees and other insiders with physical access to the device, from accessing the device in an unauthorized manner. The fact that the locking mechanism is visibly locked sends a clear signal to each would be unauthorized users that he has no right to access data on the device.

Thus, according to some embodiments, the locked configuration and the unlocked configuration are visibly different as in FIGS. 1-3. As used herein, the term “physical difference” derives from differences in the physical features of the housing surface and/or a device port where the characteristic dimension of these features are not microscopic or buried but visible.

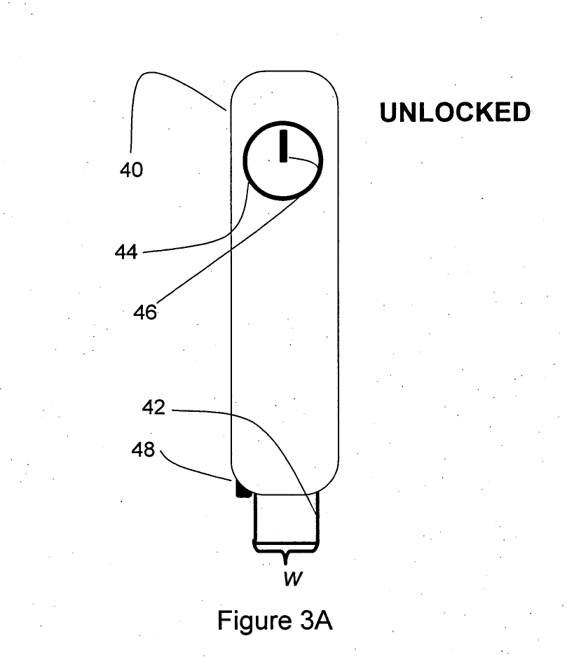

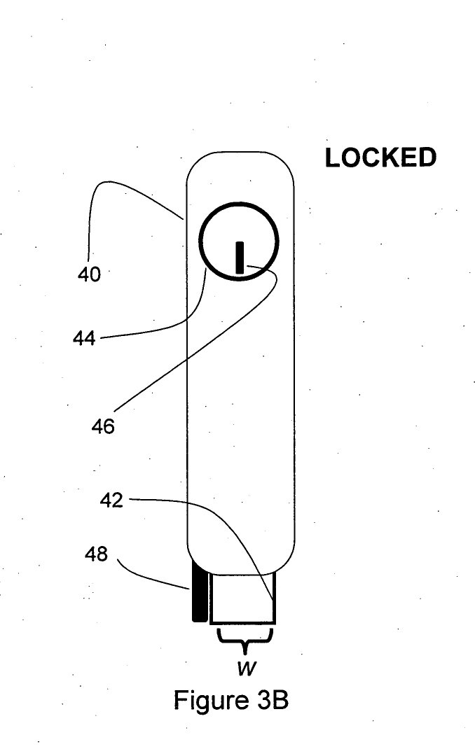

FIG. 3 provides an illustration of another system including a non-volatile memory device and a mechanical locking mechanism. In particular, the system of FIG. 3 includes a UFD 40 having a USB connector or plug 42 of a given width w. Thus, this USB connector 42 may be inserted into a host device port or socket (e.g. a USB port) or a port of an extension cable having a width whose value is substantially equal to w. Thus, the dimensions of the port appropriately match those of the USB connector 42

It is also noted that the UFD of FIG. 3 is equipped with a built-in cylinder lock, of the type commonly found on desk drawers. The lock is operable with a key that is inserted in key socket 44. The rotation of the cylinder (not shown) causes, via a cogwheel and a linear cog bar (not shown), a pin 48 to extend in a direction that is substantially parallel to the elongate axis of the connector 42.

Thus, as shown in FIGS. 3A-3B, in FIG. 3A, the pin resides within the housing of the UFD 40 and the connector is appropriately dimensioned (e.g. having a width the is substantially w) to be inserted into the USB port of the host device. Thus, in FIG. 3A the locking mechanism is in the unlocked configuration, and the non-volatile device (e.g. UFB device) may be physically coupled with the host device. In FIG. 3B, the pin 48 is extended thereby increasing the “effective width” of the connector 42 so that the connector 42 not longer fits into the USB port. Thus, the extended pin 48 in the locked position prevents both physical coupling and coupling between the UFD device 40 and the host device.

It is noted that when the non-volatile device is locked as shown in FIG. 3B, introduction of the proper mechanical key (not shown) into the keyhole 44 is operative to retract the pin 48 so that the UFD can once more be physically coupled with the host device either directly or through the extension cable.

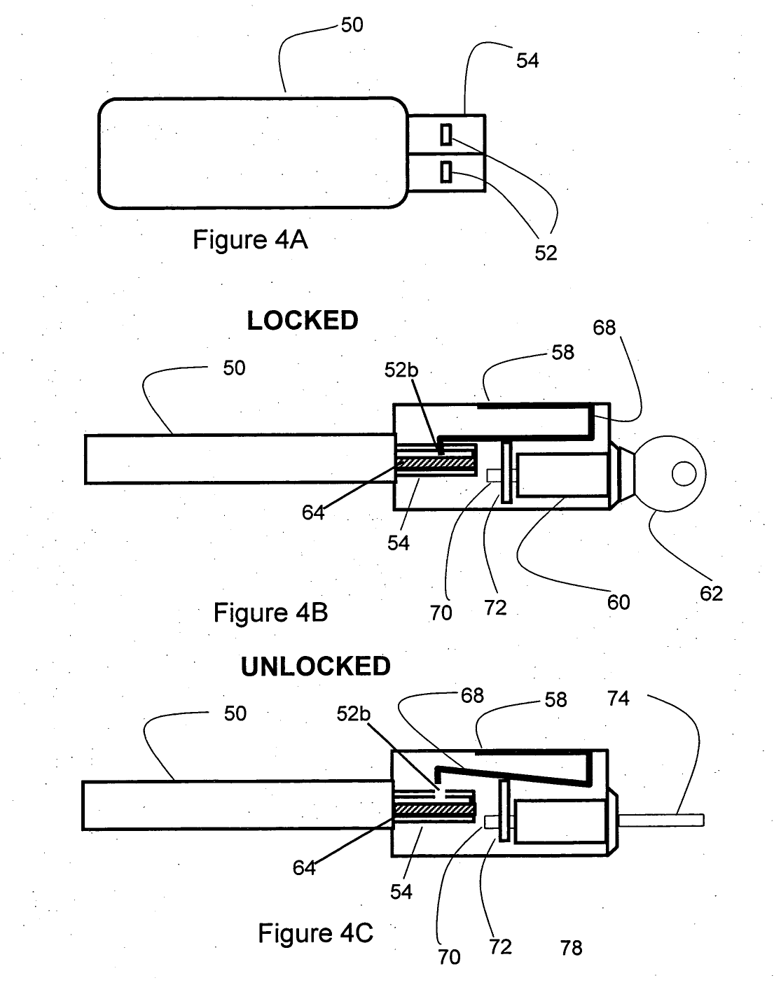

FIG. 4A provides a top view of an ordinary UFD 50 having a USB connector or plug 54. Each side of the USB connector 54 has two rectangular holes 52. On one side of the connector, the holes 52 are closer to the printed circuit 64 of the USB connector (“proximal holes” 52a, not shown), while on the opposite side the holes 52 are farther from the printed circuit 64 (“distal holes” 52b).

FIGS. 4B-4C provide side views of a system including the same UFD 50 of FIG. 4A as engaged with a mechanical locking mechanism 58 in the locked (FIG. 4B) and unlocked (FIG. 4C) configurations. The locking mechanism 58 includes a cylinder lock 60 connected to the body of the locking mechanism, and a key 62 is used to turn the cylinder 60. An axial pin 70 of the cylinder 60 is connected to an arm 72 that rotates with the axial cylinder. When the mechanism 58 is locked (as in FIG. 4B), the arm 72 is oriented sideways, allowing a flat, folded steel spring 68 that is fastened to the ceiling of the locking mechanism 58 to rest on the face of the connector 54, with the vertical split tip of the steel spring 68 penetrating into one or two of the distal rectangular holes 52b. In this position, the locking mechanism 58 cannot be removed from the connector 54, and thus the UFD cannot be connected to a USB socket. This therefore prevents coupling and physical coupling of the non-volatile memory device (e.g. the UFD 52) with the host device.

It is noted that the distal rectangular holes are specified in FIG. 4B. This is in accordance with one preferred embodiments, and is not a limitation of the present invention.

FIG. 4C provides a side view of the locking mechanism 58 engaged to the UFD 50 when in the unlocked configuration. Thus, to unlock the device the key 62 is rotated by about 90 degrees such that the arm 72 is positioned vertically to reorient and raise the spring 68 upwards and remove the vertical split tip of the steel spring 68 from the distal rectangular holes 52b. Once the tip of the spring 68 is removed from the distal holes 52b, it is possible to remove the “muzzling” locking mechanism 58 from the UFD connector 54, and to connect the UFD 50 to a USB port and physically couple the UFD 50 to a host device.

Unlike the locking mechanism of FIG. 3 which is “built into” the housing of the device, the locking mechanism of FIG. 4 is an external locking mechanism and thus may be used with prior art UFDs.

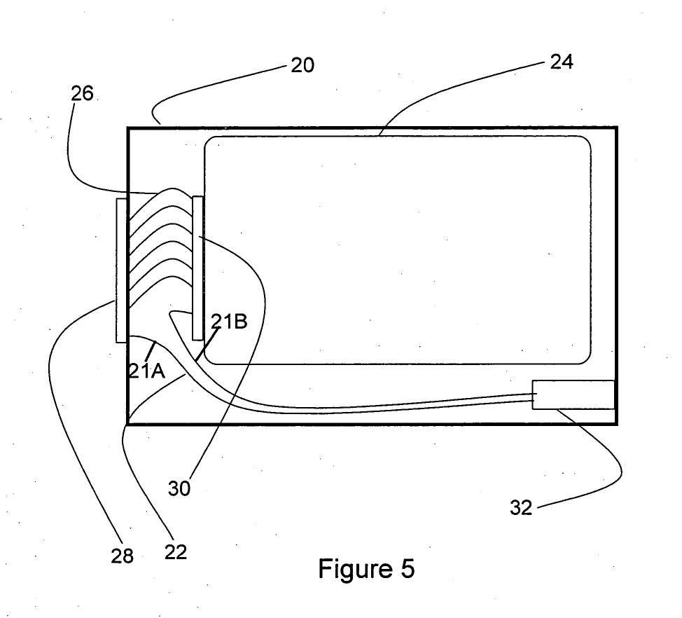

FIG. 5 provides a top view of a system including a hard disk drive 24 within an external housing 20 and a lock assembly 32 operative to reversibly prevent coupling of the hard disk drive with a host computer. The hard disk drive 24 includes an “internal” multi-pin connector 30 which is mirrored by similar “external” multi-pin connector 28 on or within the external housing 20. In particular, a plurality of connective wires 26 electrically connect each pin of the internal multi-pin connector 30 with the external multi-pin connector 28. One or more of these wires 22 is routed through the lock assembly 32 which includes a circuit breaker (not shown) that can reversibly disable electrical connectivity between respective ends (21A and 21B) of the diverted wire, and thereby reversibly preventing physical coupling of the hard disk drive with a host computer.

It is noted that any mechanism for reversibly disconnecting electrical connectivity across the diverted wire 22 is within the scope of the present invention.

In some embodiments, the lock assembly includes a mechanical lock (not shown), and motion of the proper mechanical key inserted into the mechanical lock reversibly operates the circuit breaker.

Alternatively or additionally, the lock assembly 32 includes an electronic lock (not shown) which requires a presence of a proper electronic token to provide electrical connectivity across the circuit breaker and the diverted wire.

Other mechanisms of the lock assembly 32 for reversibly providing electrical connectivity across the circuit breaker and the diverted wire 22 include but are not limited to a biometric device (e.g. fingerprint recognition device and/or a voice recognition device) and a password recognition device.

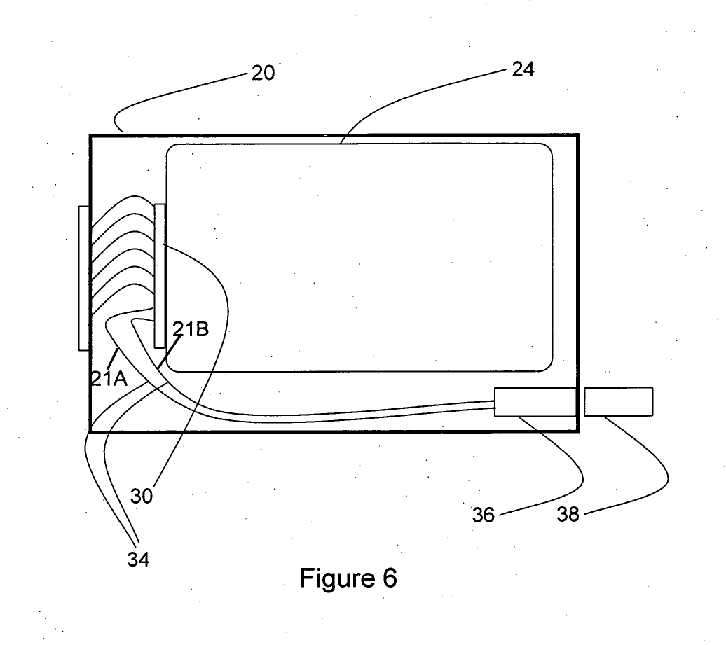

FIG. 6 provides a top view of one preferred embodiment in which the local controller of the HDD 24 within the HDD housing 20 communicates through wires 34 with an electronic token 38 such as a USB key available from Aladdin Knowledge Systems (Tel-Aviv, Israel). When the token is inserted into the token reader or token connector 36, it enables the operation of the HDD only if there is a match between the identity of the token and information stored in the HDD. This embodiment is clearly difficult to circumvent, as the locking mechanism is embedded in software stored within the HDD.

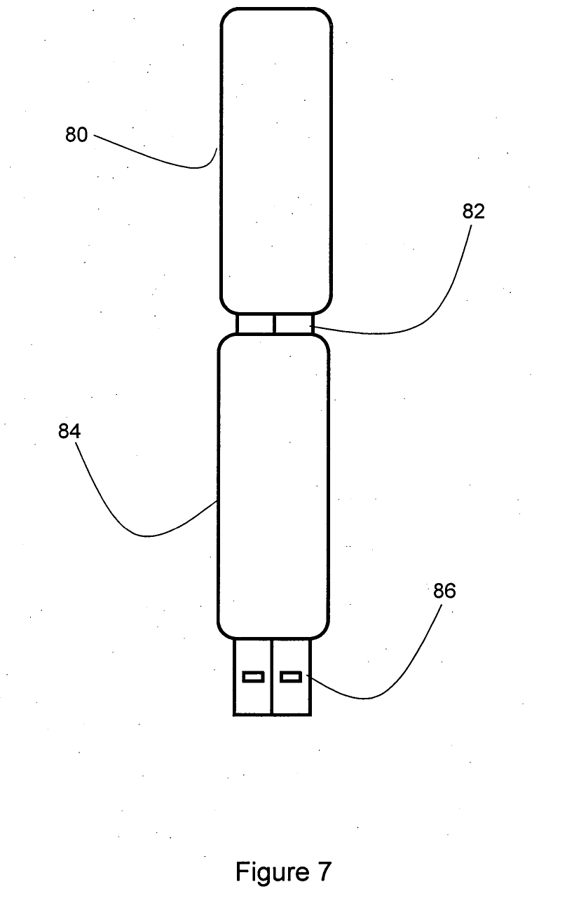

FIG. 7 provides a side view of a USB token 80 locking a UFD 84. In this embodiment, the UFD is programmed to check for the presence of an authorized token in order to operate. The USB token can be connected to the UFD via the token plug 82 and a USB socket in its rear side. It is noted that embodiments of the invention as depicted in FIG. 7 are very useful in the presence of a large number of UFD's, that can all be protected by one USB token.

It is noted that in FIGS. 6-7 that the USB tokens function as “electronic keys” or “external electronic keys.” As used herein external electronic keys are devices which may be stored outside of the housing of the non-volatile memory device which upon engaging the non-volatile memory device enables the non-volatile memory device to couple to a host device. It is noted that both “contact” electronic keys, for example USB token 80 depicted in FIG. 7, as well as “contactless” electronic keys are both within the scope of embodiments of the present invention.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1. A system for providing storage for a host device, the system comprising:
a) a non-volatile memory device for providing storage to the host when reversibly coupled to the host; and
b) a mechanical locking mechanism having locked and unlocked configurations, said locking mechanism operative to prevent said coupling of the host device to said non-volatile memory device when in said locked configuration, said mechanical locking mechanism operative to adopt said unlocked configuration upon engagement with a proper key.

2) The system of claim 1 wherein said mechanical locking mechanism physically obstructs a connection between the host device and said non-volatile memory device when in said locked configuration.

3) The system of claim 1 wherein said locking mechanism in said locked configuration prevents an insertion of said non-volatile memory device into a computer chassis of the host device.

4) The system of claim 1 wherein the system further comprises:
d) a connection cable for electrically connecting said non-volatile memory device to the host device for said coupling,
wherein said locking mechanism is operative to prevent said electrical connecting when in said locked configuration.

5) The system of claim 1 wherein said prevention includes a disconnection of electric connectivity.

6) The system of claim 1 wherein said locked configuration and said unlocked configuration are visibly different.

7) The system of claim 1 wherein said non-volatile memory device is a USB flash drive.

8) The system of claim 7 wherein said locking mechanism is an external locking mechanism.

9) The system of claim 8 wherein said USB flash drive includes an elongated connector having a plurality of holes, and said external locking mechanism includes a mechanism for engaging said holes to prevent insertion of said USB connector into a port of said host device.

10) The system of claim 8 wherein said external locking mechanism serves as a lockable cap of said USB flash drive.

11) A system for providing storage for a host device, the system comprising:
a) a non-volatile memory device for providing storage to the host when reversibly coupled to the host; and
b) a locking mechanism for preventing said coupling of the host device to said non-volatile memory device without a presence of a proper electronic token.

12) The system of claim 11 wherein said non-volatile memory device includes a port for receiving said electronic token.

13) The system of claim 111 wherein said electronic token is a contactless electronic token.

14) The system of claim 11 wherein said electronic token is a USB token.

15) The system of claim 11 wherein an identity of a recognized token is logged.

16) A system for providing storage for a host device, the system comprising:
a) a non-volatile memory device for providing storage to the host when reversibly coupled to the host; and
b) a locking mechanism for preventing physical coupling of the host device to said non-volatile memory device without a presence of a proper key.

17. A method of securing data, the method comprising:
a) providing a non-volatile memory device operative to provide storage to a host when reversibly coupled to the host;
b) providing a mechanical locking mechanism having locked and unlocked configurations, said locking mechanism operative to prevent said coupling of the host device to said non-volatile memory device when in said locked configuration, said mechanical locking mechanism operative to adopt said unlocked configuration upon engaging a proper mechanical key; and
c) placing said locking mechanism into said locked configuration to prevent said coupling of said non-volatile memory device.

18) A method of securing data, the method comprising:
a) providing a non-volatile memory device operative to provide storage to a host when reversibly coupled to the host;
b) providing a locking mechanism for preventing said coupling of the host device to said non-volatile memory device without a presence of a proper electronic token; and
c) placing said locking mechanism into said locked configuration to prevent said coupling of said non-volatile memory device.

19) A method of securing data, the method comprising:
a) providing a non-volatile memory device operative to provide storage to a host when reversibly coupled to the host; and
b) providing a locking mechanism for preventing physical coupling of the host device to said non-volatile memory device without a presence of a proper key;
c) placing said locking mechanism into said locked configuration to prevent said physical coupling of said non-volatile memory device.
